(19) United States
(12) Patent Application Publication
(10) Pub. No.: US 2013/0124294 A1
(43) Pub. Date: May 16, 2013

(54) SYSTEM AND METHOD FOR MANAGING LOYALTY PROGRAM

(71) Applicants: David F. Peak, Avon, CT (US); Taneka L. Francis, Tamarac, FL (US); Jacqueline LeSage Krause, West Hartford, CT (US); Patty Ann Jensen, Torrington, CT (US)

(72) Inventors: David F. Peak, Avon, CT (US); Taneka L. Francis, Tamarac, FL (US); Jacqueline LeSage Krause, West Hartford, CT (US); Patty Ann Jensen, Torrington, CT (US)

(73) Assignee: Hartford Fire Insurance Company, Hartford, CT (US)

(21) Appl. No.: 13/296,921

(22) Filed: Nov. 15, 2011

(51) Int. Cl. G06Q 30/02

(52) U.S. Cl. 705/14.33

(57) ABSTRACT

Systems and methods for management of financial and insurance products held by customers in a group and for administration of a loyalty and reward program for the group. Each customer in a group has an individual customer profile, which includes information about one or more insurance products held by a customer and a reward points total associated with the one or more products held by the customer. The profiles of various customers may be compiled in group data. The group attributes may include a group reward points total, which is based on the reward points total of the customers in the group. Either the individual customer reward points totals and/or the group reward points total can be applied to various transactions to receive a reward benefit.

### FIELD OF INVENTION

The invention relates to the field of insurance data processing and more particularly, to the field of group-based insurance loyalty and reward programs.

### BACKGROUND

Businesses are interested in retaining customers and fostering customer loyalty. In particular, insurance and financial services companies are interested in, among other things, increasing the number of products held by a customer, increasing the amount of money invested in the products held by a customer, increasing the length of time that these products are held by a customer, and introducing members of a customer's network (e.g., family members, co-workers) to a company's products. Important among the various factors contributing to a customer's loyalty to a company's products is the popularity of the company's products among members of a customer's network (e.g., family members, co-workers).

Various loyalty and reward programs exist to encourage customers to keep products and continue purchasing products from a company. Mainly, these loyalty and reward programs focus on incentivizing individual behavior. Generally, these existing programs are not directed to incentivizing group behavior relating to a company's products. Accordingly, it would be advantageous to provide a loyalty program that individually and collectively rewards members of a group (e.g., family members, co-workers) to incentivize individual and collective purchases of a company's products. In particular, such a loyalty program would be advantageous for insurance and financial services companies.

### SUMMARY

In one aspect, the invention relates to a computerized method for an insurance company to administer a group-based insurance loyalty and reward program. In one embodiment, the method includes creating, by the computer application executing on the processor, group data associated with a first customer and a second customer. The method also includes associating, by the computer application executing on the processor, a first customer profile and a second customer profile in the group data stored in the database. The first customer profile including information about one or more insurance products held by a first customer and a reward points total associated with the one or more products held by the first customer. The second customer profile including information about one or more insurance products held by a second customer and a reward points total associated with the one or more products held by the second customer. The method further includes applying, by the computer application executing on the processor, a reward benefit corresponding to at least a portion of the first customer's reward points total and the second customer's reward points total.

In another aspect, the invention relates to a system for an insurance company to administer a group-based insurance loyalty and reward program. In one embodiment, the system includes a database and a processor configured to execute certain functions. The processor is configured to create, in a database, group data associated with a first customer and a second customer. The processor is also configured to associate a first customer profile and a second customer profile in the group data stored in the database. The first customer profile including information about one or more insurance products held by a first customer and a reward points total associated with the one or more products held by the first customer. The second customer profile including information about one or more insurance products held by a second customer and a reward points total associated with the one or more products held by the second customer. The processor is further configured to apply a reward benefit corresponding to at least a portion of the first customer's reward points total and the second customer's reward points total.

### BRIEF DESCRIPTION OF THE FIGURES

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific embodiments disclosed. In the drawings:

FIG. 1 is a block diagram of an insurance computer network, according to an illustrative embodiment of the invention;

FIG. 2 is a block diagram of a computer system in the insurance computer network of FIG. 1, according to an illustrative embodiment of the invention;

FIG. 3 is a flowchart depicting a process for the management of financial/insurance products held by members of a group and the administration of a reward program for members of the group, according to an illustrative embodiment of the invention;

FIG. 4 is a graphical user interface associated with the process depicted in FIG. 3, according to an illustrative embodiment of the invention;

FIG. 5 is another graphical user interface associated with the process depicted in FIG. 3, according to an illustrative embodiment of the invention;

FIG. 6 is a graphical user interface associated with the process depicted in FIG. 3, according to an illustrative embodiment of the invention;

FIG. 7 is a graphical user interface associated with the process depicted in FIG. 3, according to an illustrative embodiment of the invention;

FIG. 8 is a graphical user interface associated with the process depicted in FIG. 3, according to an illustrative embodiment of the invention;

FIG. 9 is a graphical user interface associated with the process depicted in FIG. 3, according to an illustrative embodiment of the invention;

FIG. 10 is a flowchart depicting a process for making product recommendations to a customer, according to an illustrative embodiment of the invention;

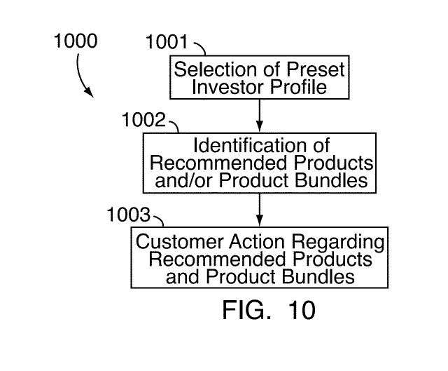

FIG. 11 is a graphical user interface associated with the process depicted in FIG. 10, according to an illustrative embodiment of the invention;

FIG. 12 is a graphical user interface associated with an application in the computer system depicted in FIG. 2, according to an illustrative embodiment of the invention; and

FIG. 13 is a graphical user interface associated with an application in the computer system depicted in FIG. 2, according to an illustrative embodiment of the invention.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. It is also to be understood that the terminology used is for the purpose of describing particular embodiments only, and is not intended to limit the scope of the claims of the present application.

The present application is directed to systems and methods for managing financial and insurance products held by customers in a group and for administering a loyalty program for the group. Each customer in a group has an individual customer profile, which includes information about one or more insurance products held by a customer and a reward points total associated with the one or more products held by the customer. The profiles of various customers may be compiled in a group. The group attributes may include a group reward points total, which may be based, at least in part, on the reward points of the individual customers in the group. Either the individual customer reward points totals and/or the group reward points total can be applied to various transactions to receive a reward benefit.

Although the systems and methods of the present application will be described with reference to insurance companies, it should be understood that the systems and methods described herein are equally applicable to other types of companies, such as, for example, financial services and wealth management companies. Also, although the description of the systems and methods of the present application may refer to customers, it should be understood that some parts of the description may apply not only to persons who have already purchased products from the company, but also to persons who have not yet purchased any products from the company. In the drawings, like reference numerals refer to like features of the systems and methods of the present application. Accordingly, although certain descriptions may refer only to certain Figures and reference numerals, it should be understood that such descriptions may be equally applicable to like reference numerals in other Figures.

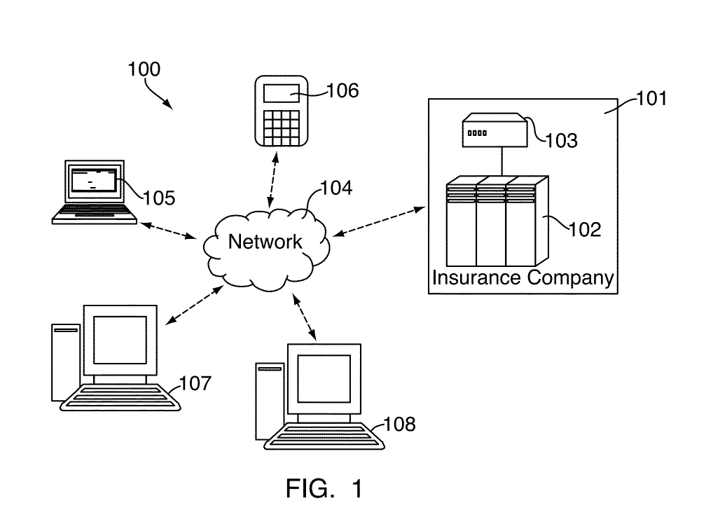

FIG. 1 is a block diagram of an insurance computer network 100, according to an illustrative embodiment of the invention. The insurance computer network 100 includes one or more insurance companies 101 with an insurance company computer system 102 and a web server 103. The insurance company 101, its computer system 102, and/or its web server 103 are linked, via network 104, to one or more customers 105, 106 and one or more third-party intermediary systems 107, 108. Web server 103 may include one or more applications or server-side application code for communicating with customers 105, 106. Web server 103 delivers web pages, markup documents and/or electronic messages generated by the server side application code to customers 105, 106. Customers 105, 106 communicate with the insurance company computer system 102 via any suitable device that is capable of communication with a web interface, such as a Personal Computer (PC), a portable computing device such as a Personal Digital Assistant (PDA) or smart-phone type device, or any other appropriate storage and/or communication device.

Web server 103 may also include a real time, bidirectional, and reliable messaging application to transmit messages to one or more third-party intermediary systems 107, 108. In the present invention, messages may include facsimiles and/or electronic mail message such as electronic mail messages based on one or more of the messaging protocols including IMAP, POP3, MIME and SMTP for sending a notification for an intermediary to contact a customer 105, 106 regarding a financial/insurance product. Third-party intermediary systems 107, 108 may comprise any suitable devices for receiving notifications (e.g., email, facsimile, etc.) from the insurance company computer system 102, such as handheld electronic devices, telephones, facsimile machines, email servers, and/or other transmission device.

The network 104 may be may be one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH® network, a wireless LAN network, and/or an Internet Protocol (IP) network such as the Internet, an intranet, or an extranet. Note that any devices described herein may communicate via one or more such communication networks. In some embodiments, different networks are used to link different components of the insurance computer network 100 together. For example, the systems associated with the insurance company 101, such as the insurance company computer system 102 and the web server 103 may be linked to each other via a private data network. In these embodiments, the insurance company 101 and/or one or more of its components are then linked to external systems and components via a public network such as the Internet or a PSTN. For example, when a customer 105, 106 accesses a webpage served by the web server 103 on the public network 104, the web server 103 may also retrieve and/or transmit data to the insurance company computer system 102 via the private data network. In other embodiments, the web server 103 may not be part of the insurance company 101. Instead, the web server 103 may be operated by third parties.

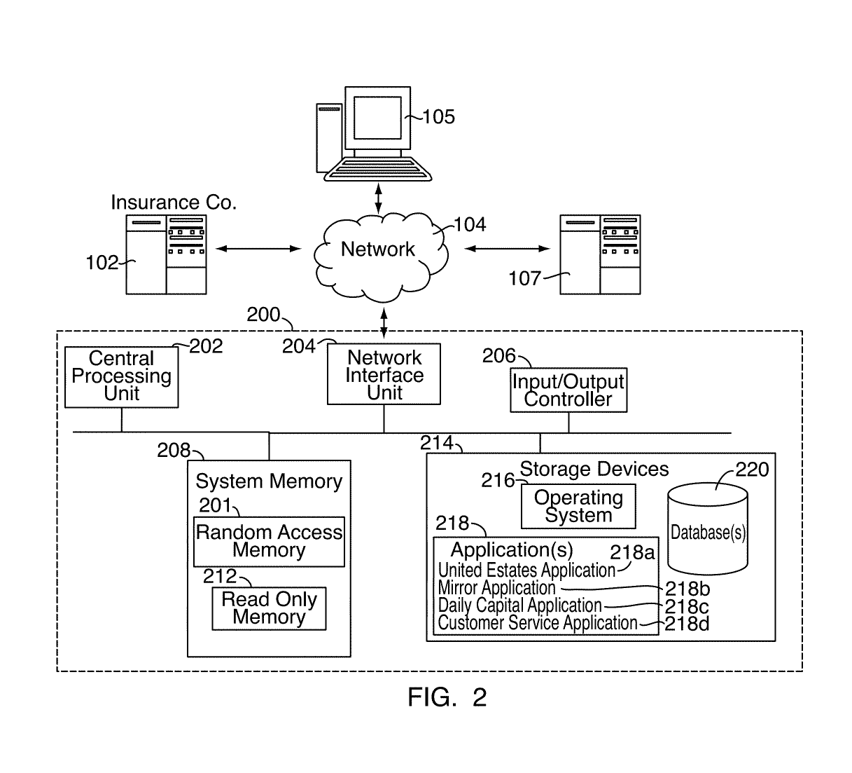

FIG. 2 is a block diagram of an insurance company computer system 200 in the insurance computer network 100 of FIG. 1, according to an illustrative embodiment of the invention. Insurance company computer system 200 comprises at least one central processing unit (CPU) 202, system memory 208, which includes at least one random access memory (RAM) 210 and at least one read-only memory (ROM) 212, at least one network interface unit 204, an input/output controller 206, and one or more data storage devices 214. All of these latter elements are in communication with the CPU 202 to facilitate the operation of the insurance company computer system 200. Suitable computer program code may be provided for executing numerous functions. For example, the computer program code may include program elements such as an operating system, a database management system and “device drivers” that allow the processor to interface with computer peripheral devices (e.g., a video display, a keyboard, a computer mouse, etc.) via the input/output controller 206.

The insurance company computer system 200 may be configured in many different ways. In the embodiment shown in FIG. 2, the insurance company computer system 200 is linked, via network 104 (also described in FIG. 1), to another insurance company computer system 102, one or more customers 105 and one or more third party intermediary systems 107. Insurance company computer system 200 may be a conventional standalone computer or alternatively, the function of computer system 200 may be distributed across multiple computing systems and architectures. In some embodiments, insurance company computer system 200 may be configured in a distributed architecture, wherein databases and processors are housed in separate units or locations. Some such units perform primary processing functions and contain at a minimum, a general controller or a processor 202 and a system memory 208. In such an embodiment, each of these units is attached via the network interface unit 204 to a communications hub or port (not shown) that serves as a primary communication link with other servers, client or user computers and other related devices. The communications hub or port may have minimal processing capability itself, serving primarily as a communications router. A variety of communications protocols may be part of the system, including but not limited to: Ethernet, SAP®, SAS®, ATP, BLUETOOTH®, GSM and TCP/IP.

The CPU 202 comprises a processor, such as one or more conventional microprocessors and one or more supplementary co-processors such as math co-processors. The CPU 202 is in communication with the network interface unit 204 and the input/output controller 206, through which the CPU 202 communicates with other devices such as other servers, user terminals, or devices. The network interface unit 204 and/or the input/output controller 206 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 202 is also in communication with the data storage device 214. The data storage device 214 may comprise an appropriate combination of magnetic, optical and/or semiconductor memory, and may include, for example, RAM, ROM, flash drive, an optical disc such as a compact disc and/or a hard disk or drive. The CPU 202 and the data storage device 214 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 202 may be connected to the data storage device 214 via the network interface unit 204.

The data storage device 214 may store, for example, (i) an operating system 216 for the insurance company computer system 200; (ii) one or more applications 218 (e.g., computer program code and/or a computer program product) adapted to direct the CPU 202 in accordance with the present invention, and particularly in accordance with the processes described in detail with regard to the CPU 202; and/or (iii) database(s) 220 adapted to store information that may be utilized to store information required by the program. Various applications 218 may be executed by insurance company computer system 200—including a United Estates Application 218a, a Mirror Application 218b, a Daily Capital Application 218c and a Customer Service Application 218d. Database(s) 220 stores information regarding financial/insurance products held by customers 105, 106 in customer profiles and group attributes. Database(s) 220 may include a database management system (DBMS) software of a relational database type, such as a DB2 UNIVERSAL DATABASE™ provided by International Business Machines Corporation, an Access™ product provided by Microsoft Corporation or an Oracle® Database product provided by Oracle Corporation for storing and processing information related to workers compensation related complaint information in the present invention. In some embodiments, database(s) 220 may also provide certain database query functions such as generation of structured query language (SQL) in real time to access and manipulate the data.

The operating system 216 and/or applications 218 may be stored, for example, in a compressed, an uncompiled and/or an encrypted format, and may include computer program code. The instructions of the computer program code may be read into a main memory of the processor from a computer-readable medium other than the data storage device 214, such as from the ROM 212 or from the RAM 210. While execution of sequences of instructions in the program causes the processor 202 to perform the process steps described herein, hard-wired circuitry may be used in place of, or in combination with, software instructions for implementation of the processes of the present invention. Thus, embodiments of the present invention are not limited to any specific combination of hardware and software.

An application may also be implemented in programmable hardware devices such as field programmable gate arrays, programmable array logic, programmable logic devices or the like. Applications may also be implemented in software for execution by various types of computer processors. An application of executable code may, for instance, comprise one or more physical or logical blocks of computer instructions, which may, for instance, be organized as an object, procedure, process or function. Nevertheless, the executables of an identified application need not be physically located together, but may comprise separate instructions stored in different locations which, when joined logically together, comprise the application and achieve the stated purpose for the application such as implementing the business rules logic prescribed by system 200. In the present invention an application of executable code may be a compilation of many instructions, and may even be distributed over several different code partitions or segments, among different programs, and across several devices. Similarly, customer data may be identified and illustrated herein within applications, and may be embodied in any suitable form and organized within any suitable type of data structure. Such data may be collected as a single data set, or may be distributed over different locations including over different storage devices, and may exist, at least partially, merely as electronic signals on a system and/or network as shown and describe herein.

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 202 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

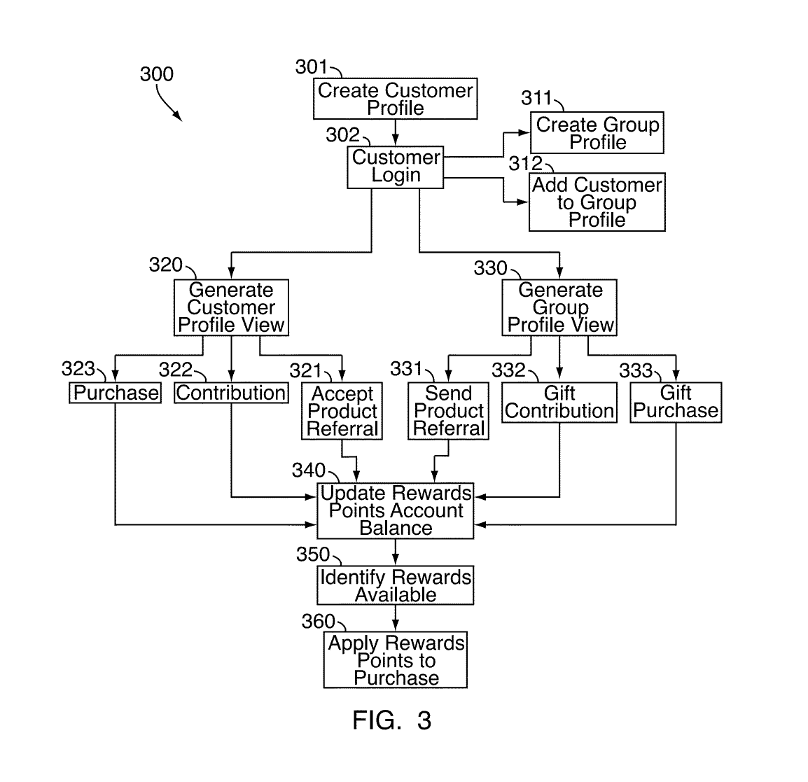

FIG. 3 is a flowchart depicting a process 300 for the management of financial/insurance products held by members of a group and the administration of a reward program for members of the group, according to an illustrative embodiment of the invention. Process 300 may be performed by, for example, the United Estates Application 218a of computer systems 102, described with reference to FIGS. 1 and 2. Process 300 will be described with reference to computer system 200 shown in FIG. 2, but it should be understood that the description of process 300 is equally applicable to computer system 102 shown in FIG. 1. It should be understood that the methods described herein are exemplary embodiments of the present invention. Accordingly, in other embodiments, additional steps may be added and/or certain steps may be omitted, as desired. Furthermore, the flow charts described herein do not imply a fixed order to the steps, and embodiments of the present invention may be practiced in any order that is practicable. Note that any of the methods described herein may be performed by hardware, software, or any combination of these approaches. For example, a storage medium may store thereon instructions that when executed by a machine result in performance according to any of the embodiments described herein.

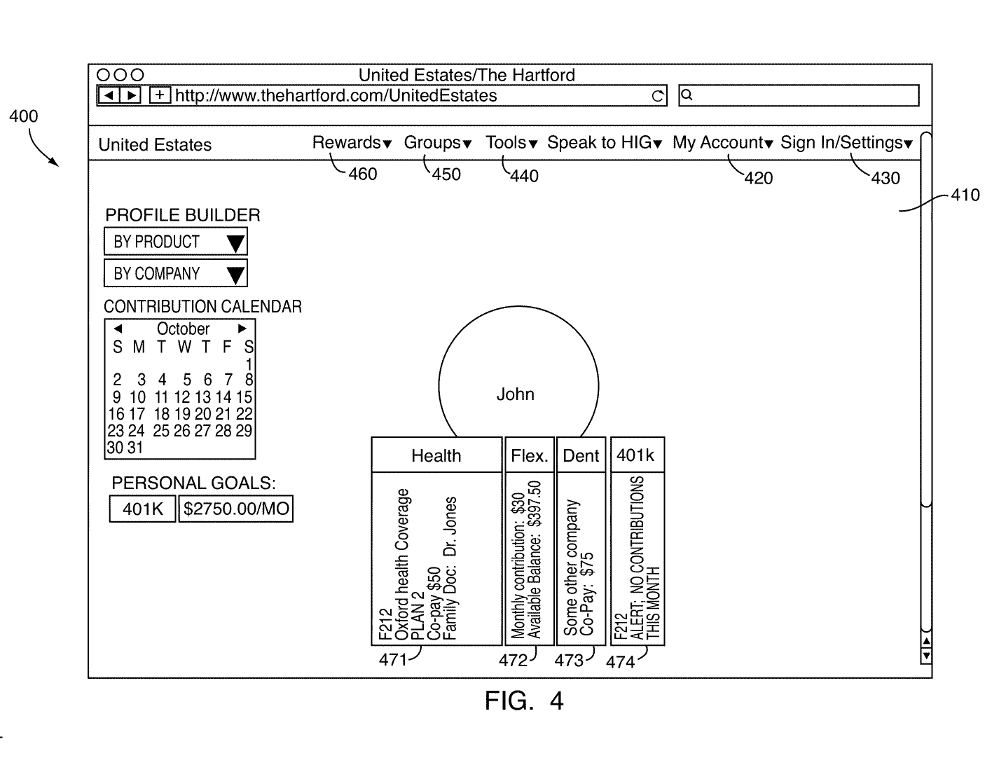

Process 300 includes a step 301 for the creation of a customer profile. In step 301, the insurance company computer system 200 provides a dynamic graphical user interface using one or more dynamic Web forms to collect information regarding a customer's 105 financial/insurance product holdings. The insurance company computer system 200 prompts the customer, via the dynamic graphical user interface, to identify the customer's insurance and financial products. The insurance and financial products may be from insurance company 101 and/or other companies. The products may include auto insurance, home insurance, life insurance, disability insurance, mutual funds, annuities, college savings accounts, and retirement savings accounts. For products offered by insurance company 101, each of the products identified may be linked to the corresponding product database so that information about the customer's product holding may be automatically collected. For products that are not offerings from insurance company 101, information about the product holding may be entered or submitted by the customer. Additionally, the insurance company computer system 200 prompts the customer, via the dynamic graphical user interface, to identify the customer's intermediary(ies) for the products (e.g., insurance agent, broker-dealer, registered representative, etc.). The insurance company computer system 200 uses the information about the customer's financial/insurance product holdings and the customer's intermediary(ies) to create a customer profile 410. Additionally, in step 301, the insurance company computer system 200 may also request and retrieve additional information related to the customer's financial/insurance products from databases corresponding to the specific products held by the customer. Further, in step 301, the insurance company computer system 200 may link the customer profile 410 with the various databases corresponding to the products held by the customer. The customer's financial/insurance products may correspond to various product categories and various business units across the insurance company 101. Accordingly, these databases may be located in the insurance computer system 200 or they may be located in separate computer systems of different business units of the insurance company 101. Further, in step 301, the customer profile 410 is stored in the insurance computer system 200. For example, FIG. 4 illustrates a graphical user interface 400 for displaying a customer profile 410 that is stored in the insurance computer system 200. Access to the insurance company computer system 200 and the customer profile 410 is protected by a customer ID and password, which is also established in the creation of the customer profile 410 in step 301.

The customer profile 410 of the present invention is advantageous because it provides a consolidated view of a customer's product holdings 471-474 across an insurance company's various business units and range of product categories that may not otherwise be related. As a result, the customer profile 410 provides an insurance company 101 with a better understanding of a customer's needs, which the insurance company 101 can use to cross sell financial/insurance products from its various business units. Also, the insurance company 101 can use the information gleaned from a customer's profile 410 to reward and incentivize a customer's behavior with respect to the insurance company's 101 whole range of products.

In step 302, once a customer profile 410 has been created, the insurance company computer system 200 can grant a customer access to his customer profile 410 upon authentication of the customer through a login process using the customer ID and password established in step 301. In step 302, the insurance company computer system 200 provides a web-based dynamic graphical user interface for prompting the customer for a customer ID and password. Once the insurance company computer system 200 authenticates the customer's ID and password, the customer is granted access to the insurance company computer system 200 and his customer profile 410.

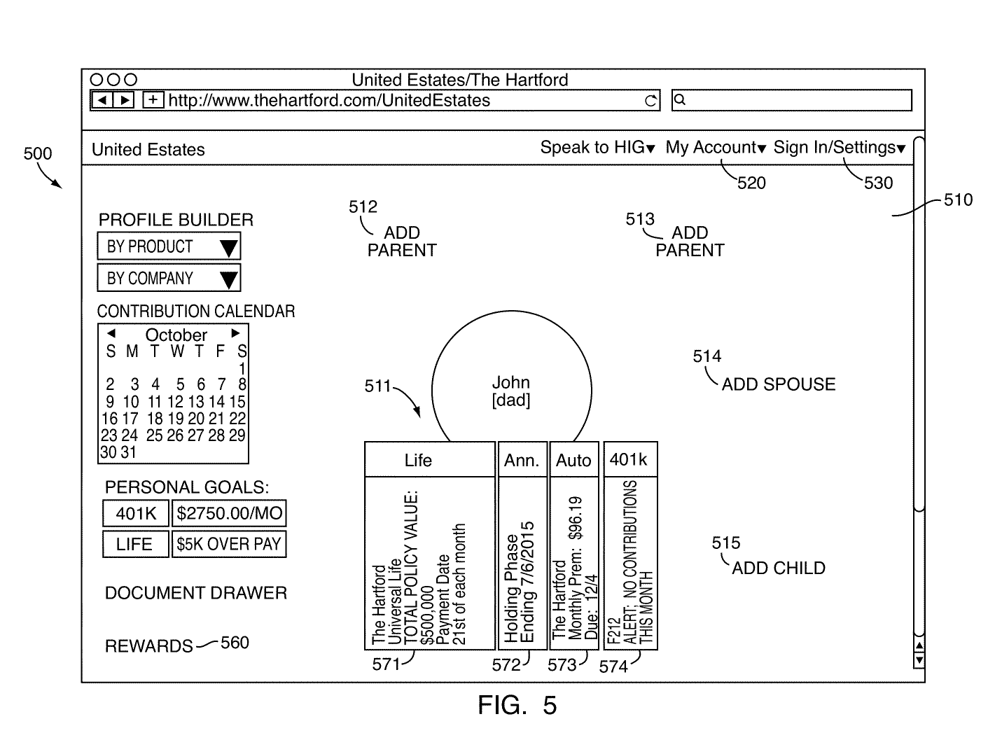

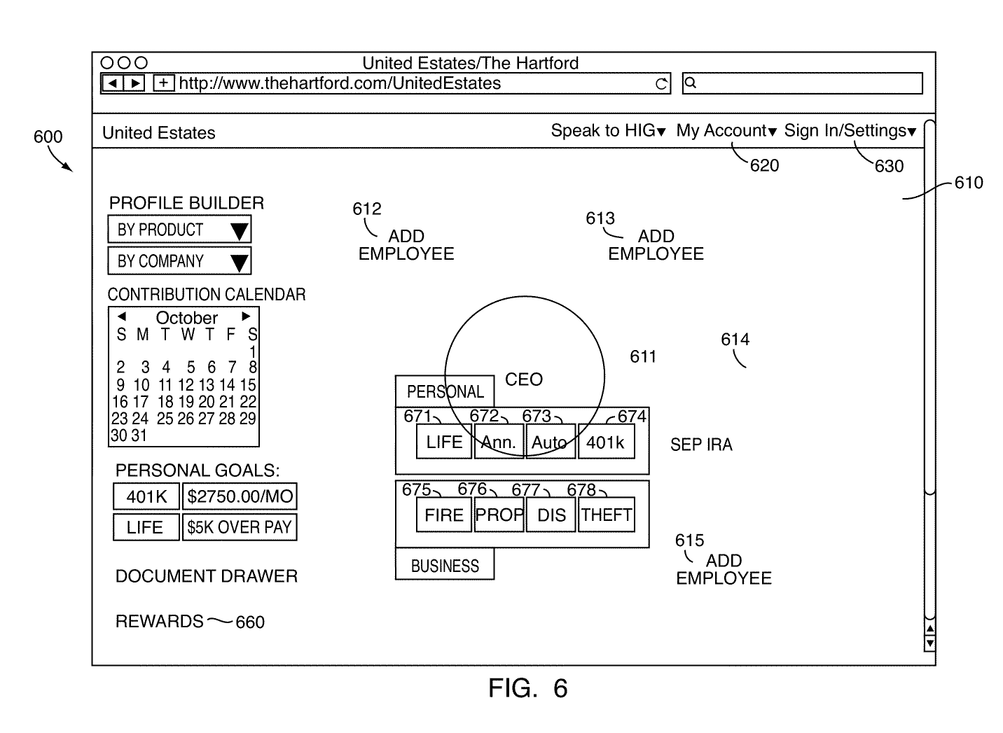

In step 311, the insurance company computer system 200 receives and processes a customer's request to create a group. Step 311 will be described with reference to graphical user interface 500 shown in FIG. 5, but it should be understood that the description of step 311 is equally applicable to graphical user interface 600 shown in FIG. 6. In step 311, the insurance company computer system 200 provides a web-based dynamic graphical user interface 500, which allows a user to create a group 510. FIG. 5 shows an exemplary web-based graphical user interface 500 for creating group 510. The web-based dynamic graphical user interface 500 includes privacy controls 530 for designating which portions 571-574 of a customer profile 511 can be viewed by other customers that are members of the group 510. For example, a customer may designate which products or types of products can be displayed to the group 510. Further, for the products displayed to the group 510, the customer can further select which product information is to be shown to the group 510. For example, a customer may elect to show a particular product (e.g., life insurance), but decide to block the coverage amount and/or the beneficiary(ies). A customer's privacy controls 530 are received by the insurance company computer system 200 and are applied to the display settings of the group 510.

The web-based dynamic graphical user interface 500 may provide a customer with options for creating different types of groups (e.g., family group, business group, etc.). FIG. 5 shows a graphical user interface 500 for creating a family group 510. FIG. 6 shows a graphical user interface 600 for creating a business group 610. In step 311, the web-based dynamic graphical user interface 500 allows a customer to add other group members 512-515 to the group 510. The web-based dynamic graphical user interface 500 also allows a customer to indicate the group members 512-515 to be invited to join the group 510 and the relationships of the group member with one another. Additionally, in step 311, the web-based dynamic graphical user interface 500 prompts the user to provide contact information (e.g., email addresses) for the group members 512-515 to be invited to the group 510. In step 311, the insurance company computer system 200 receives and processes the information regarding the customers 512-515 to be added to a group 510, and sends invitation notifications to the appropriate group members 512-515. The invitation notifications include links to a web-based dynamic graphical user interface for joining the group or other information (e.g., telephone number, email address, etc.) for contacting a company representative to accept the invitation. A customer may invite both persons who are already customers of the insurance company or persons who are not yet customers of the insurance company to join a group.

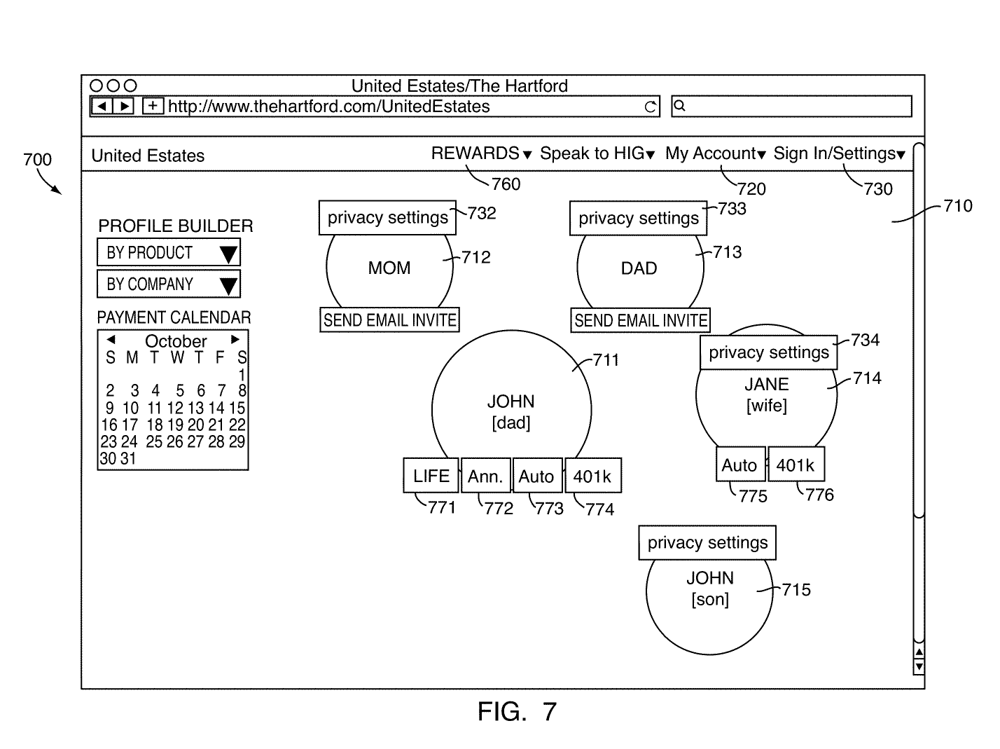

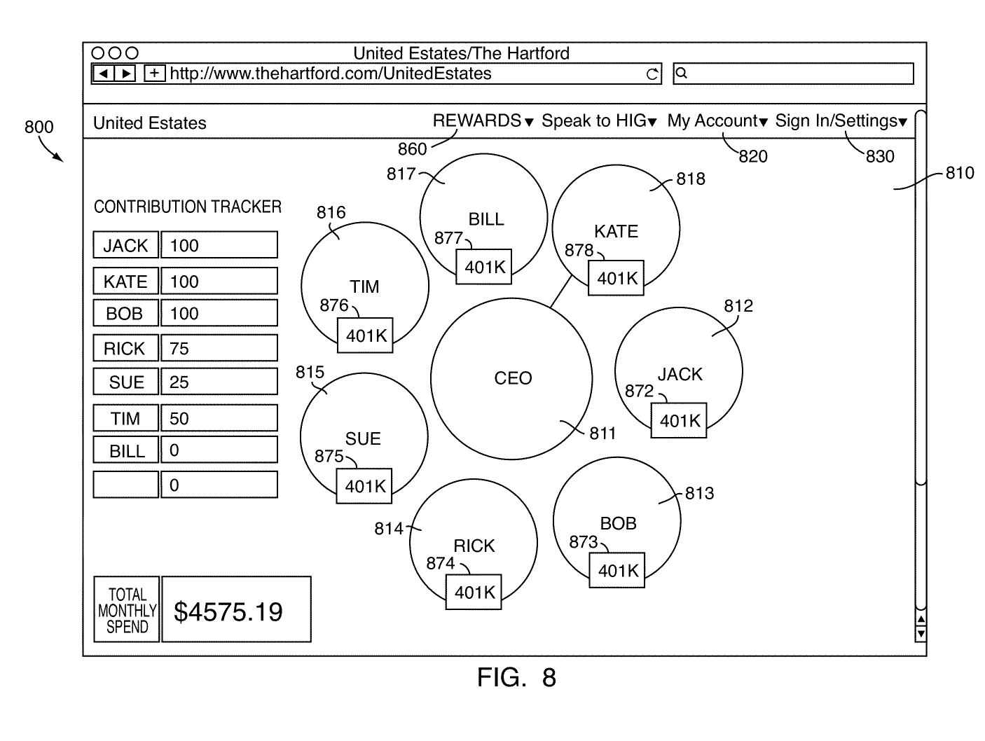

In step 312, the insurance company computer system 200 receives and processes a customer's request to join a group 710 (i.e., an acceptance of an invitation to join a group). Step 312 will be described with reference to graphical user interface 700 shown in FIG. 7, but it should be understood that the description of step 312 is equally applicable to graphical user interface 800 shown in FIG. 8. Further, although step 312 will be described with reference to customers, it should be understood that not all members of a group may be customers of the insurance company. FIGS. 7 and 8 show exemplary web-based graphical user interfaces for displaying group attributes. FIG. 7 shows a graphical user interface 700 for a family group 710. FIG. 8 shows a graphical user interface 800 for a business group 810. After the insurance company computer system 200 sends a customer an invitation notification in step 311, the customer can accept the invitation by following a link to the web-based dynamic graphical user interface 700 for joining the group 710. Alternatively, in response to a group invitation notification, a customer can accept the invitation by calling a call center or sending a message (e.g., email) to a company representative. When the customer follows the invitation's link to the web-based dynamic graphical user interface 700, a request to join the group is sent to and received by the insurance company computer system 200 in a step 312. In step 312, if the customer has an existing customer profile, the insurance company computer system 200 prompts the customer to login using his customer ID and password through the web-based dynamic graphical user interface 700 to authenticate the customer and the invitation notification. However, if in step 312, the customer does not have an existing customer profile, a customer must be authenticated by the creation of a new customer profile in accordance with step 301, as described above. In step 312, once the customer and the invitation notification have been authenticated, the insurance company computer system 200 prompts the customer through the web-based dynamic graphical user interface 700 to confirm that his customer profile 714, 715 should be added to the group 710. The web-based dynamic graphical user interface 700 also includes privacy controls 730-734, which allow a customer to designate the portions of his customer profile 711-715 that can be viewed by other members of the group 710. Further, in step 312, a customer's confirmation to include his customer profile 711-715 in the group 710 and the privacy controls 730-734 are received by the insurance company computer system 200 and are applied to the display settings of the group 710.

In step 320, the insurance company computer system 200 receives and processes a customer's request to view his customer profile 410. In step 320, in response to the customer's request to view his customer profile 410, the insurance company computer system 200 provides a view of customer profile 410 through a web-based graphical user interface 400. As shown in FIG. 4, the web-based graphical user interface 400 may include, among other things, a listing of the insurance and financial products 471-474 held by the customer, account management options 420, privacy controls 430, links to planning tools 440, links to groups that the customer has created or joined 450, and customer reward points balance 460. As shown in FIG. 4, the web-based graphical user interface 400 provides a listing of the products 471-474 that the customer holds. The listing may include insurance and financial products from insurance/financial company 101 and/or other companies. The listing of products may include auto insurance, home insurance, life insurance, disability insurance, mutual funds, annuities, college savings accounts, and retirement savings accounts. For products offered by insurance/financial company 101, each of the products displayed in graphical user interface 400 may be linked to the various databases corresponding to the products so that the information displayed about the various products can be automatically updated as the characteristics of the product holdings change. For products that are not offerings from insurance/financial company 101, the information displayed is information that is entered and/or submitted by the customer.

As shown in FIG. 4, the web-based graphical user interface 400 may include a menu with account management options 420, which the customer can select to execute various transactions. For example, the account management options 420 may allow a customer to accept another customer's product referral, make a contribution to an existing product, and purchase a new product. As shown in FIG. 4, the web-based dynamic graphical user interface 400 includes privacy controls 430 for designating which portions 471-474 of a customer profile 410 to display. For example, a customer may designate which products or types of products to display and can further select which product information to display. A customer's privacy controls 430 are received by the insurance company computer system 200 and are applied to the display settings of the customer profile 510. Also, as shown in FIG. 4, the web-based graphical user interface 400 may include a menu with links to planning tools 440, which may include retirement savings calculators, insurance/financial product recommendation tools, financial planning tools, various product/service surveys, and the Mirror Application 218b, the Daily Capital Application 218c and the Customer Service Application 218d described in more detail below. As shown in FIG. 4, the web-based graphical user interface 400 may further include a menu with links to groups 450 that the customer has created or joined. The group links 450 provide access to graphical user interfaces that display group attributes as shown in FIG. 5-8. Further, as shown in FIG. 4, the web-based graphical user interface 400 may also include a link to the customer's reward points balance 460.

In step 321, the insurance company computer system 200 receives and processes a customer's request to accept another customer's product referral. In step 321, the insurance company computer system 200 may provide a web-based graphical user interface including a display of information regarding the product referral, a link for setting up an appointment (e.g., virtual meeting, live in-person meeting) with the customer's intermediary to discuss the product, and a link to directly purchase the product. Additionally, in step 321, the customer communicates, via the web-based graphical user interface, whether the customer would like to consult with his intermediary regarding the product referral or whether the customer would like to directly purchase the product. The insurance company computer system 200 receives and processes the customer's request. Accordingly, in step 321, the insurance company computer system 200 links to and communicates with third party intermediary systems 107, 108 (as shown in FIG. 2) for setting up an appointment with the customer's intermediary. Additionally, in step 321, the insurance company computer system 200 links to and communicates with the insurance company computer system 102 corresponding to the particular product of the product referral (as shown in FIGS. 1 and 2) to execute a purchase of the product. Note that the customer's intermediary may ultimately execute the purchase of the product in the product referral. Accordingly, both the link for setting up an appointment with the customer's intermediary to discuss the product and the link to directly purchase the product include a unique referral ID so that the insurance company computer system 200 can properly credit the account of the customer who made the product referral with the corresponding reward point once the product purchase is confirmed. The insurance company computer system 200 determines the quantity of reward points corresponding to the referral and the purchase of the product based on factors, such as type of product and value of the product. The products offerings may include auto insurance, home insurance, life insurance, disability insurance, mutual funds, annuities, college savings accounts, and retirement savings accounts.

In step 322, the insurance company computer system 200 receives and processes a customer's request to make a contribution to a customer's existing product. In step 322, the insurance company computer system 200 may provide a web-based graphical user interface including a display of the various products held by the customer and links for making contributions to particular products. Additionally, in step 322, the customer identifies, via the web-based graphical user interface, the product to which the customer would like to make a contribution and the amount of the contribution. The product holdings may include auto insurance, home insurance, life insurance, disability insurance, mutual funds, annuities, college savings accounts, and retirement savings accounts. The insurance company computer system 200 receives and processes the customer's request. Accordingly, in step 322, the insurance company computer system 200 links to and communicates with the insurance company computer system(s) 102 (as shown in FIG. 2) corresponding to the various products held by the customer to execute a contribution to the product designated by the customer, in the amount designated by the customer. In an alternative embodiment, the contribution request may be sent to the customer's intermediary (e.g., agent or broker of record) to be executed. Also, in step 322, the insurance company computer system 200 determines the quantity of reward points to be awarded to the customer for the contribution to the existing product, based on factors such as the type of product, the amount of the contribution and the length of time that the customer has held the product.

In step 323, the insurance company computer system 200 receives and processes a customer's request to purchase a new product. In step 323, the insurance company computer system 200 may provide a web-based graphical user interface including a display of the various products that the insurance company 101 offers. The product offerings may include auto insurance, home insurance, life insurance, disability insurance, mutual funds, annuities, college savings accounts, and retirement savings accounts. Additionally, in step 323, the customer indicates, via the web-based graphical user interface, the product that the customer would like to purchase. The insurance company computer system 200 receives and processes the customer's request. Accordingly, in step 323, the insurance company computer system 200 links to and communicates with the insurance company computer system(s) 102 (as shown in FIG. 2) corresponding to the various products offered to execute the purchase designated by the customer. In an alternative embodiment, the purchase request may be sent to the customer's intermediary (e.g., agent or broker of record) to be executed. Also, in step 323, the insurance company computer system 200 determines the quantity of reward points to be awarded to the customer for the purchase of the new product, based on factors such as the type of product and the value of the product.

In step 330, the insurance company computer system 200 receives and processes a customer's request to view group data 720, which includes the customer's profile 710. FIGS. 7 and 8 show exemplary web-based graphical user interfaces for displaying group attributes. Step 330 will be described with reference to graphical user interface 700 shown in FIG. 7, but it should be understood that the description of step 330 is equally applicable to graphical user interface 800 shown in FIG. 8. Graphical user interface 700 for group 710 may be accessed from graphical user interface 400 for a customer profile 410, which includes a link to graphical user interface 700. In step 330, in response to the customer's request to view group data 710 the insurance company computer system 200 displays the attributes of group 710 through a web-based graphical user interface 700, as shown in FIG. 7. The group 710 attributes may be stored and updated in a database 220 and linked to the customer profiles that are part of group 710, so that the group attributes may be viewed through graphical user interface 700, which can be accessed from a customer profile 410. Alternatively, the group 710 attributes may be stored and updated in the customer profiles 410 of the members of group 710.

FIG. 7 shows a graphical user interface 700 for a family group 710. As shown in FIG. 7, the web-based graphical user interface 700 may include, among other things, a listing of family members 711-715 in the group, insurance and financial products 771-776 held by the family members, account management options 720, and family group reward points balance 760. The listing of insurance and financial products 771-776 associated with individual family members 711-715 are displayed in accordance with the privacy settings designated by the individual family members, as described above in connection with step 311. The web-based graphical user interface 700 may include account management options 720 for product referrals and gifting, which a family member can select to execute various transactions. For example, the account management options may allow a family member to send another family member a product referral, make a contribution to another family member's existing product, and purchase a new product for another family member. Also, the web-based graphical user interface 700 may include a link to the group's reward points balance 760, which may be determined in accordance with the description of step 340 below. The group's reward points balance 760 may offer family members options to allocate reward points from their individual customer profiles 410 to the group's reward points balance 760.

FIG. 8 shows a graphical user interface 800 for a business group 810 that offers a group benefits program (e.g., 401K, term life insurance, short/long term disability insurance). As shown in FIG. 8, the web-based graphical user interface 800 may include, among other things, a listing of employees 811-818 in the group, insurance and financial products 872-878 held by the employees, account management options 820, and group reward points balance 860. The listing of insurance and financial products 872-878 associated with individual employees are displayed in accordance with the privacy setting designated by the employees, as described above in connection with step 311. The web-based graphical user interface 800 may include account management options 820, which an employee can select to execute various transactions (e.g., making contributions). Also, the web-based graphical user interface 800 may include a link to the group's reward points balance 860, which may be determined in accordance with the description of step 340 below.

The creation and management of group data 710 in the present invention is advantageous because it provides a consolidated view of various related customers' holdings across an insurance company's various business units and range of product categories that may not otherwise be related. The product holdings may include auto insurance, home insurance, life insurance, disability insurance, mutual funds, annuities, college savings accounts, and retirement savings accounts. As a result, the consolidation of group data 710 provides opportunities for cross selling financial/insurance products. For example, a consolidated group view allows group members to easily make product referrals to other group members and allows group members to easily make gift contributions and/or gift purchases for other group members. Also, the insurance company 101 can use the information gleaned from group data 710 to reward and incentivize the behavior of a group of customers. For example, an insurance company 101 may offer a group reward and/or a group discount if a number of group members decides to purchase a certain product. With respect to group 810, graphical user interface 800 may be useful to a group benefits program administrator 811. The graphical user interface 800 allows a group benefits administrator 811 to see which employees have opted in/out and the level of contribution. For example, this type of information may be useful in the administration of a 401K program. For employers who have specific matching rules in place, this information may be useful in determining the employer's anticipated matching contributions. For employers who have pooled funds, this information may be useful in determining the anticipated distribution of the pooled funds.

In step 331, the insurance company computer system 200 receives and processes a customer's request to send a product referral to another customer. In step 331, the insurance company computer system 200 may provide a web-based graphical user interface including a display of the various customer profiles 711-715 that are part of the group 710 as shown in FIG. 7. Additionally, in step 331, the customer can indicate, via the web-based graphical user interface, which product(s) the customer would like to include in a product referral and to whom the customer would like to send the product referral. The insurance company computer system 200 receives and processes the customer's request. Accordingly, in step 321, the insurance company computer system 200 sends a product referral notification to the designated customer(s) in the group. The product referral notification may include information regarding the product referral, a link for setting up an appointment (e.g., virtual meeting, live in-person meeting) with an intermediary to discuss the product referral, and a link to purchase the product(s). Both the link for setting up an appointment with the customer's intermediary to discuss the product referral and the link to directly purchase the product(s) include a unique referral ID so that the insurance company computer system 200 can properly credit the account of the customer who made the product referral with the corresponding reward point once the product purchase is confirmed. The insurance company computer system 200 determines the quantity of reward points corresponding to the referral and the purchase of the product based on factors, such as type of product and value of the product.

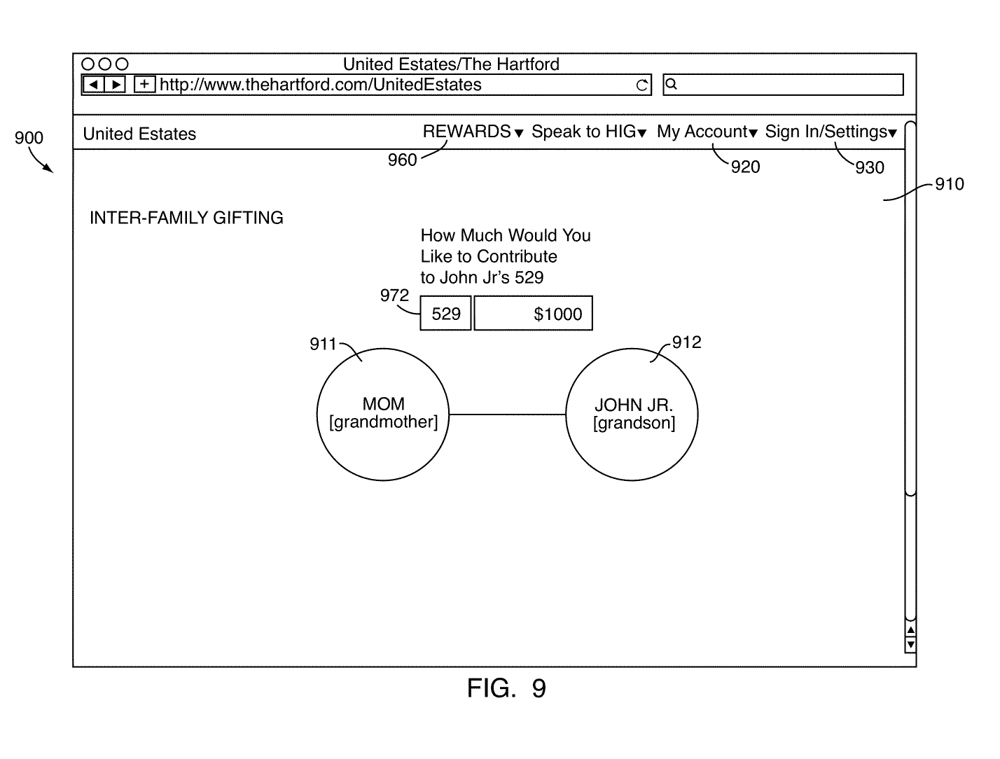

In step 332, the insurance company computer system 200 receives and processes a customer's request to make a gift contribution to another customer in the group. In step 332, the insurance company computer system 200 may provide a web-based graphical user interface including a display of the various customer profiles 711-715 that are part of the group 710 as shown in FIG. 7. Additionally, in step 332, the customer identifies, via the web-based graphical user interface 900, another customer in the group to whom the customer wishes to make a gift contribution, and the product and the amount of the contribution, as shown in FIG. 9. The insurance company computer system 200 receives and processes the customer's request. Accordingly, in step 332, the insurance company computer system 200 links to and communicates with the insurance company computer system 102 (as shown in FIG. 2) corresponding to the products held by the other customers in the group in order to execute a gift contribution to the product designated by the customer, in the amount designated by the customer. Also, in step 322, the insurance company computer system 200 determines the quantity of reward points to be awarded to the customer for the gift contribution to the other customer's existing product, based on factors such as the type of product, the amount of the contribution and the length of time that the other customer has held the product.

In step 333, the insurance company computer system 200 receives and processes a customer's request to make a gift purchase of a new product for another customer in the group. In step 333, the insurance company computer system 200 may provide a web-based graphical user interface including a display of the various customer profiles 711-715 that are part of the group 710, as shown in FIG. 7. Additionally, in step 333, the customer identifies, via the web-based graphical user interface, another customer in the group for whom the customer wishes to make a gift purchase, and the product to be purchased and the value. The insurance company computer system 200 receives and processes the customer's request. Accordingly, in step 333, the insurance company computer system 200 links to and communicates with the insurance company computer system 102 (as shown in FIG. 2) corresponding to the various products offered to execute the gift purchase designated by the customer. Also, in step 333, the insurance company computer system 200 determines the quantity of reward points to be awarded to the customer for the gift purchase of the new product, based on factors such as the type of product and the value of the product.

In step 340, the insurance company computer system 200 updates reward points account balances for individual customers. The reward points account balances for individual customers are updated based on reward points determinations for various transactions, such as those described in connection with steps 321-323, 331-333. Additionally, reward points may be awarded for other types of actions. For example, reward points may be awarded to a customer for participating in other types of services and programs offered by the insurance company, which may be directed to educating and exposing customers to products offered across an insurance company's various business units and range of product categories. These services and programs may include retirement savings calculators, insurance/financial product recommendation tools, financial planning tools, various product/service surveys, and the Mirror Application 218b, the Daily Capital Application 218c and the Customer Service Application 218d described in more detail below.

Further, in step 340, the insurance company computer system 200 updates the reward points account balances 760 for groups of customers. The group reward points balance 760 may be based on individual group member's reward points balances 460 as well as reward points awarded for group actions. For example, group reward points may be awarded if a predetermined number of group members purchase a product that is part of a product promotion. Additionally, the individual customer actions described above may also have associated group reward points awarded. The reward points account balance 760 for a group of customers may be calculated in accordance with various schemes. For example, in one implementation, a group's reward points balance 760 may be based on the cumulative total of the reward points of the individual customers in the group. In another implementation, a group's reward points 760 total may be assigned based on the cumulative reward points total of the group members reaching certain threshold levels. For example, 10,000 cumulative individual reward points may translate to 1,000 group points; 20,000 cumulative individual reward points may translate to 2,500 group points; 30,000 cumulative individual reward points may translate to 4,500 group points; and so forth. In yet another implementation, a group's reward points 760 total may be calculated based on a predetermined percentage of the cumulative reward points total of the group members. For example, if the group point percentage is 15% and the cumulative reward points total of the group members is 25,000 points, the group's reward points total would be 3,750 points. In still another implementation, a group's reward points 760 total may be based on each group member's specific points allocation from his individual reward points balance to the group's reward points balance. The above schemes for determining a group's reward points balance 760 are described for illustrative purposes only and implementation of step 340 is not limited to these schemes. Additionally, the schemes described above and/or other suitable schemes may be implemented in various combinations. Accordingly, the insurance company computer system 200 maintains an accounting of reward points 460 for individual customers, as well as groups of customers 760 based on the schemes or combination of schemes described above. And the insurance company computer system 200 makes reward points available for use by individual customers, as well as groups of customers.

In step 350, the insurance company computer system 200 identifies various rewards available to an individual customer based on the individual customer's reward points account balance 460. Also, the insurance company computer system 200 identifies various rewards available to a group of customers based on the group reward points balance 760. The rewards may include, for example, discounts on the purchase of a new product, upgrades to the purchase of a new product, increased coverage for existing insurance products, reduced or disappearing deductibles for existing insurance products, additional riders to existing life insurance products, accident forgiveness, or other benefits. Reward benefits may be transferred or shared with other customers, for example, other customers in a group.

In step 360, the insurance company computer system 200 receives a request to apply a quantity of reward points toward the purchase of a new product, such as those described in connection with steps 321, 323, 331, 333. In step 360, the insurance company computer system 200 determines whether the quantity of reward points to be applied to the purchase of a product are being contributed by a single customer, by various customers, and/or by a group. Also in step 360, if the quantity of reward points is contributed by a single customer, the system determines if the customer's reward points account balance 460 is sufficient. If the customer's account balance 460 is sufficient, the insurance company computer system 200 deducts the quantity of reward points from the customer's account balance 460, and applies the corresponding reward (e.g., discount, upgrade) to the purchase of the new product. Also in step 360, if the quantity of reward points is contributed by some combination of customer(s) and/or group(s), the system determines each customer's and/or group's designated reward points contribution, and determines whether each customer's 460 and/or group's 760 account balance is sufficient. If each customer's 460 and/or group's 760 account balance is sufficient to contribute the designated reward points contribution, the insurance company computer system 200 deducts the designated reward points contribution from each customer's 460 and/or group's 760 account balance, and applies the corresponding reward (e.g., discount, upgrade) to the purchase of the new product.

In accordance with another aspect of the invention, provided is a process 1000 for making product recommendations to a customer. Process 1000 may be performed by, for example, the Mirror Application 218b of computer system 200, described with reference to FIGS. 1 and 2. Process 1000 may be performed in connection with process 300, and the Mirror Application 218b associated with process 1000 may be linked with the United Estates Application 218a associated with process 300.

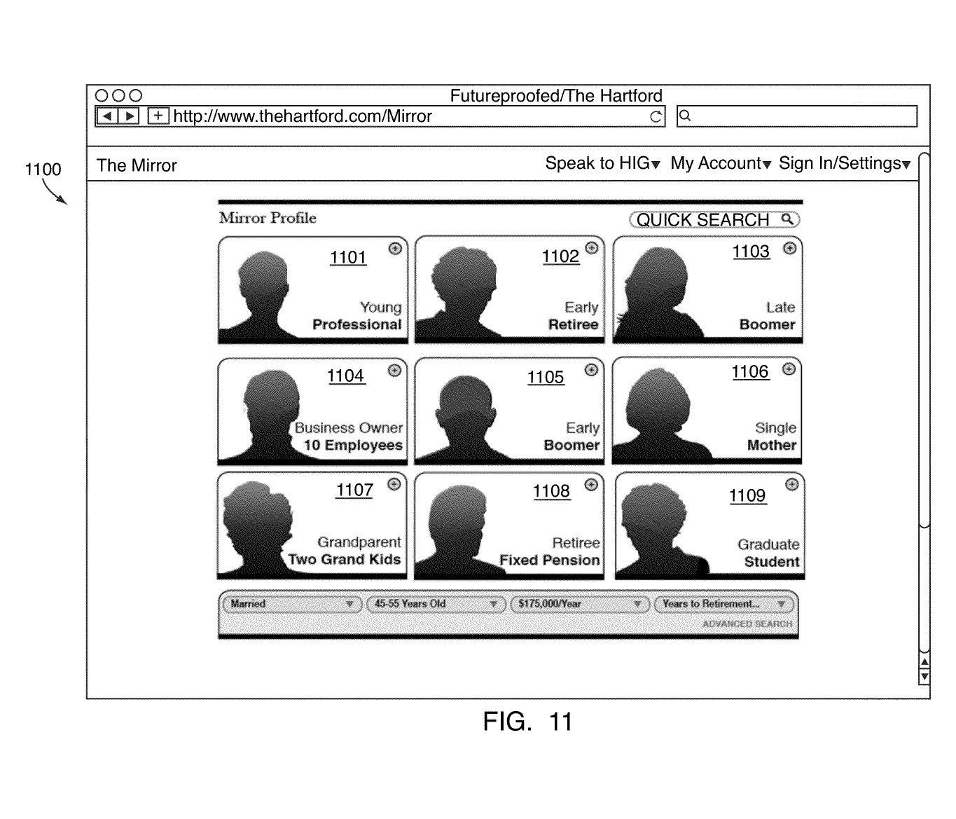

In step 1001, a customer selects a preset investor profile. In step 1001, the insurance company computer system 200 may provide a web-based graphical user interface 1100, including a display of various preset investor profiles 1101-1109, which a customer can select based on which preset investor profile best matches the customer's personal or business profile. The customer's selection of a preset investor profile 1101-1109, via the web-based graphical user interface 1100, is received and processed by the insurance company computer system 200. An exemplary embodiment of the web-based graphical user interface 1100 associated with step 1001 is illustrated in FIG. 11.

In step 1002, the insurance company computer system 200 identifies individual products and/or product bundles to recommend to the customer based on the preset investor profile selected by the customer. Also in step 1002, the insurance company computer system 200 presents to the customer the recommended individual products and/or product bundles via the web-based graphical user interface. Each product or product bundle recommendation includes a link for purchasing the product or product bundle, and a link for setting up an appointment with the customer's intermediary to discuss the product or product bundle.

In step 1003, the customer indicates, via the web-based graphical user interface, whether the customer would like to directly purchase a recommended product or product bundle, or whether the customer would like to consult with his intermediary regarding the recommended product and/or product bundles. The insurance company computer system 200 receives and processes the customer's request. Accordingly, in step 321, the insurance company computer system 200 links to and communicates with third party intermediary systems 107, 108 (as shown in FIGS. 1 and 2) for setting up an appointment with the customer's intermediary. Additionally, in step 321, the insurance company computer system 200 links to and communicates with the insurance company computer system 200 corresponding to the particular product of the product referral (as shown in FIGS. 1 and 2) to execute a purchase of the product. The insurance company computer system 200 determines the quantity of reward points corresponding to the purchase of the product(s) and/or product bundle(s) based on factors, such as type of product and value of the product. This determination of the reward points corresponding to the purchase transaction may be used in conjunction with step 340 of process 300, as described above, for updating reward points account balances for individual customers and groups of customers.

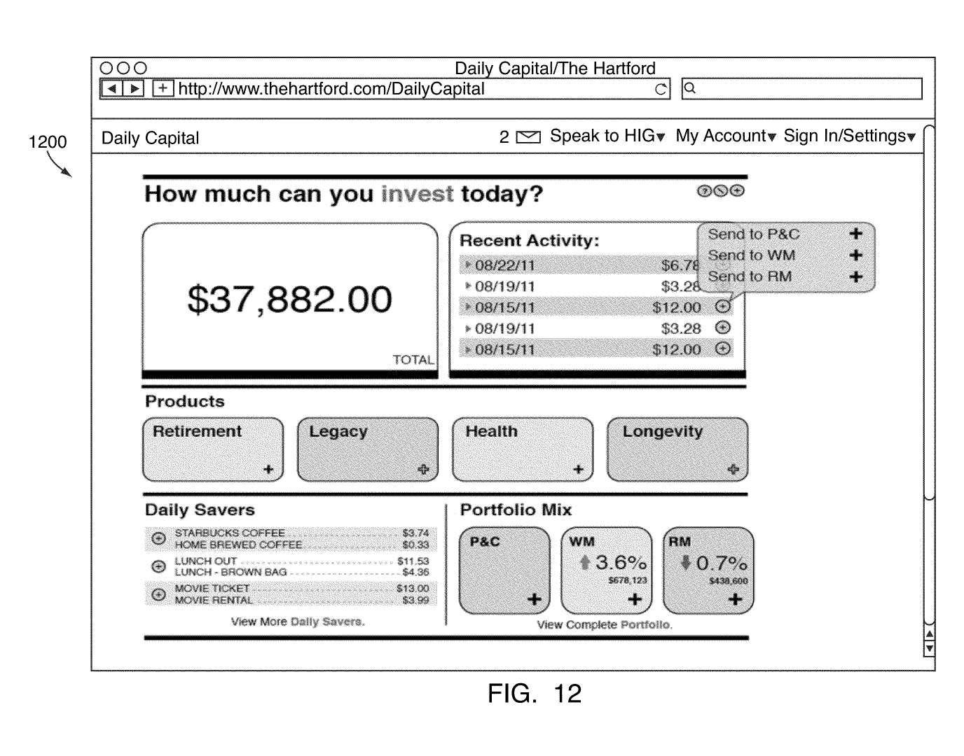

In accordance with another aspect of the invention, provided is the Daily Capital Application 218c of computer system 200, described with reference to FIG. 2. The Daily Capital Application 218c may be used in connection with step 322 of process 300 and may be linked with and accessed from the United Estates Application 218a associated with process 300. The Daily Capital Application 218c provides a web-based graphical user interface 1200, which allows customers to manage their contributions to various financial/insurance products, as shown in FIG. 12. A customer identifies, via the web-based graphical user interface, the product to which the customer would like to make a contribution, the amount of the contribution, and the frequency of the contribution (e.g., daily). The Daily Capital Application 218c allows customers to handle a large financial goal (e.g., purchase of a product with a high up-front contribution) as smaller more manageable goals (e.g., small daily contributions toward the purchase of the product).

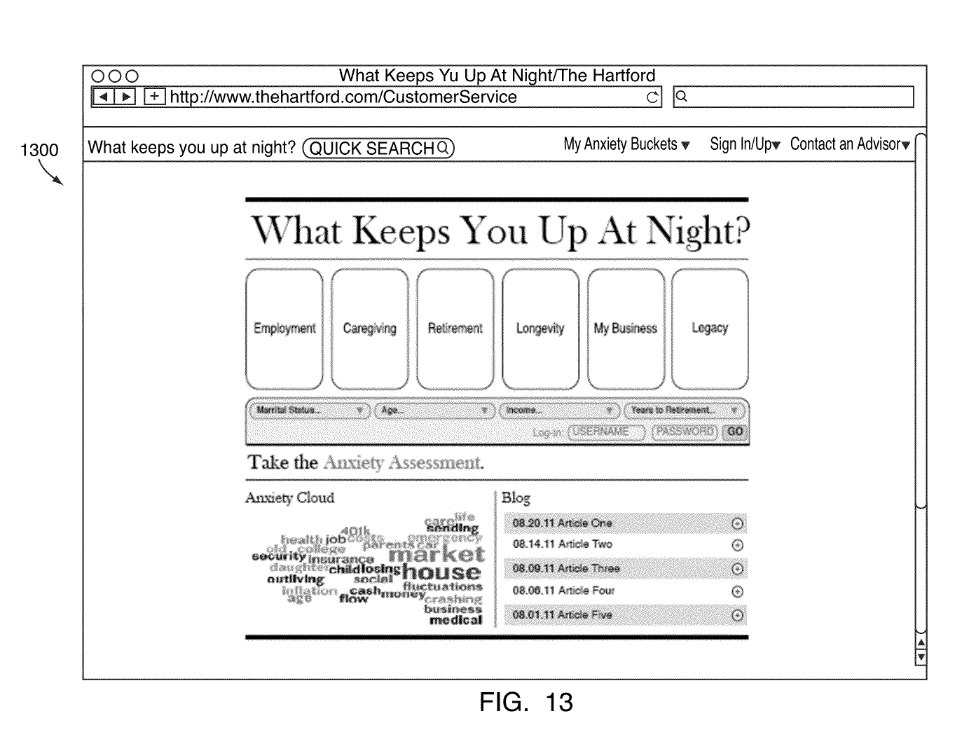

In accordance with another aspect of the invention, provided is the Customer Service Application 218d of computer system 200, described with reference to FIG. 2. The Customer Service Application 218d may be used in connection with process 300 and may be linked with and accessed from the United Estates Application 218a associated with process 300. As shown in FIG. 13, the Customer Service Application 218 provides a web-based graphical user interface 1300, which allows customers to get answers to questions regarding financial/insurance products. The web-based graphical user interface provides a decision tree mechanism that takes a customer through a problem solving process and leads the customer to an Answers Page with the insurance company's products and educational information regarding the products. The web-based graphical user interface also provides a hotline to a financial consultant and social networking platform where customers can share their experiences and offer advice to one another.

What is claimed is:

1. A computerized method for an insurance company to administer a group-based insurance loyalty and reward program, comprising:
creating, by the computer application executing on the processor, group data associated with a first customer;
sending, by the computer application executing on the processor, an electronic invitation to a second customer to join a group;
associating, by the computer application executing on the processor, a first customer profile and a second customer profile in the group data stored in the database, the first customer profile including information about one or more insurance products held by a first customer and a reward points total associated with the one or more products held by the first customer, the second customer profile including information about one or more insurance products held by a second customer and a reward points total associated with the one or more products held by the second customer;
determining, by the computer application executing on the processor, a group reward points total based at least in part on the first customer's reward points total and the second customer's reward points total; and
applying, by the computer application executing on the processor, a reward benefit corresponding to at least a portion of the group reward points total to a product purchase transaction executed by the processor.

2. The method of claim 1, wherein each of the first and second customer profiles include privacy settings for controlling third-party accessibility to the information about the one or more insurance products held.

3. The method of claim 2, wherein the privacy settings include selections of which products to show to third parties.

4. The method of claim 3, wherein the privacy settings include selections of which information about each of the products to show to third parties, wherein the information includes at least one of coverage amount and beneficiary(ies).

5. The method of claim 1, further comprising updating, by the computer application executing on the processor, the first customer's reward points total and the second customer's reward points total based on product transactions executed by the processor.

6. The method of claim 1, further comprising linking the first customer profile in the database to one or more insurance servers corresponding to the one or more insurance products held by the first customer.

7. The method of claim 1, further comprising linking the second customer profile in the database to one or more insurance servers corresponding to the one or more insurance products held by the second customer.

8. The method of claim 1, further comprising identifying, by the computer application executing on the processor, reward benefits corresponding to at least a portion of the first customer's reward points total or at least a portion of the second customer's reward points total.

9. The method of claim 8, further comprising identifying, by the computer application executing on the processor, reward benefits corresponding to at least a portion of the group reward points total.

10. A system for an insurance company to administer a group-based insurance loyalty and reward program, comprising:
a database; and
at least one processor configured to:
create, in a database, group data associated with a first customer;
associate a first customer profile and a second customer profile in the group data stored in the database, the first customer profile including information about one or more insurance products held by a first customer and a reward points total associated with the one or more products held by the first customer, the second customer profile including information about one or more insurance products held by a second customer and a reward points total associated with the one or more products held by the second customer; and
apply a reward benefit corresponding to at least a portion of the cumulative total of the first customer's reward points total and the second customer's reward points total.

11. The method of claim 10, wherein each of the first and second customer profiles include privacy settings for controlling third-party accessibility to the information about the one or more insurance products held.

12. The method of claim 11, wherein the privacy settings include selections of which products to show to third parties.

13. The method of claim 12, wherein the privacy settings include selections of which information about each of the products to show to third parties, wherein the information includes at least one of coverage amount and beneficiary(ies).

14. The system of claim 10, wherein the processor is further configured to update the first customer's reward points total and the second customer's reward points total based on product transactions executed by the processor.

15. The system of claim 10, wherein the processor is further configured to link the first customer profile in the database to one or more insurance servers corresponding to the one or more insurance products held by the first customer.

16. The system of claim 15, wherein the processor is further configured to link the second customer profile in the database to one or more insurance servers corresponding to the one or more insurance products held by the second customer.

17. The system of claim 10, wherein the processor is further configured to identify reward benefits corresponding to at least a portion of the first customer's reward points total.

18. The system of claim 10, wherein the processor is further configured to identify reward benefits corresponding to at least a portion of the second customer's reward points total.

19. The system of claim 10, wherein the processor is further configured to identify reward benefits corresponding to at least a portion of the cumulative total of the first customer's reward points total and the second customer's reward points total.

20. A computerized method for an insurance company to administer a group-based insurance loyalty and reward program, comprising:
creating, by the computer application executing on the processor, group data associated with a first customer and a second customer;
associating, by the computer application executing on the processor, a first customer profile and a second customer profile in the group data stored in the database, the first customer profile including information about one or more insurance products held by a first customer and a reward points total associated with the one or more products held by the first customer, the second customer profile including information about one or more insurance products held by a second customer and a reward points total associated with the one or more products held by the second customer; and
applying, by the computer application executing on the processor, a reward benefit corresponding to at least a portion of the first customer's reward points total and the second customer's reward points total.

21. The method of claim 20, wherein each of the first and second customer profiles include privacy settings for controlling third-party accessibility to the information about the one or more insurance products held.

22. The method of claim 21, wherein the privacy settings include selections of which products to show to third parties.

23. The method of claim 22, wherein the privacy settings include selections of which information about each of the products to show to third parties, wherein the information includes at least one of coverage amount and beneficiary(ies).

24. The method of claim 20, further comprising updating, by the computer application executing on the processor, the first customer's reward points total and the second customer's reward points total based on product transactions executed by the processor.

25. The method of claim 20, further comprising linking the first customer profile in the database to one or more insurance servers corresponding to the one or more insurance products held by the first customer.

26. The method of claim 20, further comprising linking the second customer profile in the database to one or more insurance servers corresponding to the one or more insurance products held by the second customer.

27. The method of claim 20, further comprising identifying, by the computer application executing on the processor, reward benefits corresponding to at least a portion of the first customer's reward points total.

28. The method of claim 27, further comprising identifying, by the computer application executing on the processor, reward benefits corresponding to at least a portion of the second customer's reward points total.

29. The method of claim 20, further comprising identifying, by the computer application executing on the processor, reward benefits corresponding to at least a portion of the first customer's reward points total and the second customer's reward points total.
